(19) United States
(12) Patent Application Publication
(10) Pub. No.: US 2020/0329266 A1
(43) Pub. Date: Oct. 15, 2020

(54) INFORMATION PROCESSING APPARATUS, METHOD FOR PROCESSING INFORMATION, AND STORAGE MEDIUM

(71) Applicant: CANON KABUSHIKI KAISHA, Tokyo (JP)

(72) Inventor: Masahiko Takaku, Rennes (FR)

(21) Appl. No.: 16/911,146

(22) Filed: Jun. 24, 2020

Related U.S. Application Data
(63) Continuation of application No. PCT/JP2018/047434, filed on Dec. 25, 2018.

(30) Foreign Application Priority Data
Dec. 27, 2017 (JP) 2017-251208

(51) Int. Cl. H04N 21/2343; H04N 21/235; G06F 16/78; G06F 16/74; H04N 21/84

(52) U.S. Cl. CPC H04N 21/234327; H04N 21/2353; H04N 21/84; G06F 16/745; G06F 16/7867

(57) ABSTRACT

For enabling a reception apparatus to appropriately know the direction of a video, a CPU of a video transmission apparatus generates, for two or more second videos corresponding to two or more different directions generated from a first video, direction data indicating the two or more directions. The CPU also generates transmission URLs to be used by the reception apparatus for acquiring any of the second videos, and generates metadata in which the second videos are associated with the transmission URLs and the direction data.

### CROSS-REFERENCE TO RELATED APPLICATIONS

This application is a Continuation of International Patent Application No. PCT/JP2018/047434, filed Dec. 25, 2018, which claims the benefit of Japanese Patent Application No. 2017-251208, filed Dec. 27, 2017, both of which are hereby incorporated by reference herein in their entirety.

### BACKGROUND OF THE INVENTION

### Field of the Invention

The present invention relates to techniques for handling metadata about items such as video data.

### Description of the Related Art

In recent years, video streaming techniques for transmitting video data using web-based technologies such as HTTP and playing a video in a web browser have become widespread, One of especially widely used features of these techniques is in a mode in which metadata about video data to be transmitted is communicated in advance, and a reception apparatus uses the metadata to request the actual video data from a transmission apparatus.

With the increased demand for higher video data resolutions, methods for obtaining a particular part of a high-resolution video have been proposed in connection with the above scheme,

A conventional method for writing metadata for spatially extracting, e.g., a video part in a specific position from video data and transmitting the extracted video part is defined in the MPEG-DASH SRD specifications disclosed in, e.g., ISO/IEC 23009-1: 2014/Amd 2: 2015. This metadata allows describing the position of a rectangular video to be extracted relative to the entire video such as an omnidirectional video, and the size of the rectangular video. Another method involves attaching a reference direction as metadata to a video in order to facilitate identifying the direction when an omnidirectional image (for example, a fish-eye image) is played as a viewer-friendly panoramic image. This method is disclosed in documents such as Japanese Patent Application Laid-Open No. 2013-27012, Further, a technique for generating multiple videos with different center positions and key positions from a video such as an omnidirectional video is known.

A reception apparatus may request distribution of video data based on descriptions in the above-mentioned metadata. In this case, for a rectangular video to be extracted from the entire video such as an omnidirectional video, the reception apparatus cannot know which direction in the omnidirectional video the rectangular video corresponds to. It is therefore difficult for the reception apparatus to request distribution of a video part, in the omnidirectional video, corresponding to a direction desired for display.

In view of the above, an object of the present invention is to enable a reception apparatus to appropriately know the direction of a video.

### SUMMARY OF THE INVENTION

The present invention includes an information processing apparatus including: a direction information generation unit that generates, for two or more second videos corresponding to two or more different directions generated from a first video, direction information indicating the two or more directions; an address generation unit that generates address information to be used by a reception apparatus for acquiring any of the second videos; and a metadata generation unit that generates metadata in which the two or more second videos are associated with the address information and the direction information.

Further features of the present invention will become apparent from the following description of exemplary embodiments with reference to the attached drawings.

### BRIEF DESCRIPTION OF THE DRAWINGS

FIG. 1 is a block diagram illustrating a configuration of an information processing system in an embodiment.

FIG. 2A is a diagram illustrating an example of converting a 360-degree video into an equirectangular video.

FIG. 2B is a diagram illustrating an example of converting the 360-degree video into an equirectangular video.

FIG. 2C is a diagram illustrating an example of converting the 360-degree video into an equirectangular video.

FIG. 2D is a diagram illustrating an example of converting the 360-degree video into an equirectangular video.

FIG. 3 is a flowchart illustrating a flow from video conversion to video transmission.

FIG. 4 is a diagram illustrating an example of metadata in an exemplary case of MPEG-DASH.

FIG. 5A is a diagram illustrating an example of converting the 360-degree video into a cube.

FIG. 5B is a diagram illustrating an example of converting the 360-degree video into a cube.

FIG. 5C is a diagram illustrating an example of converting the 360-degree video into a cube.

FIG. 5D is a diagram illustrating an example of converting the 360-degree video into a cube.

FIG. 6 is a diagram illustrating another example of metadata in an exemplary case of MPEG-DASH.

FIG. 7A is a diagram illustrating an example of generating 240-degree videos from a cylinder.

FIG. 7B is a diagram illustrating an example of generating a 240-degree video from the cylinder.

FIG. 7C is a diagram illustrating an example of generating a 240-degree video from the cylinder.

FIG. 7D is a diagram illustrating an example of generating a 240-degree video from the cylinder.

FIG. 8 is a diagram illustrating another exemplary manifest file.

FIG. 9 is a diagram illustrating a further exemplary manifest file.

### DESCRIPTION OF THE EMBODIMENTS

Embodiments of the present invention will be described in detail below with reference to the accompanying drawings. The following embodiments illustrate exemplary implementations of the present invention, and the present invention is not limited to these embodiments.

### First Embodiment

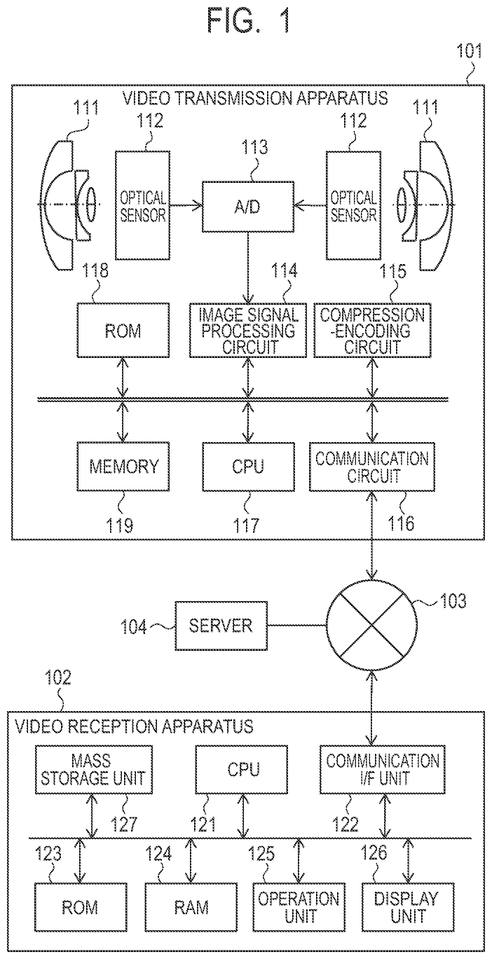

FIG. 1 is a diagram illustrating an exemplary configuration of an information processing system that includes a video transmission apparatus 101 and a video reception apparatus 102 in a first embodiment.

The video transmission apparatus 101 is an information processing apparatus capable of transmitting video data over a network 103. The video reception apparatus 102 is an information processing apparatus capable of receiving video data over the network 103. As an example, this embodiment describes video streaming transmission according to MPEG-DASH. As will be described in detail below, the video transmission apparatus 101 can perform a video generation process for generating MPEG-DASH-compliant video data, and can also generate and transmit metadata about videos to be transmitted. The video reception apparatus 102 can use the metadata obtained in advance to request distribution of the MPEG-DASH-compliant video data. The video data generated by the video transmission apparatus 101 is transmitted in response to a request from the video reception apparatus 102. The video data may be accumulated in, e.g., a web server 104 and then distributed to the video reception apparatus 102.

The video transmission apparatus 101 may be implemented as a camera having a communication function, or as one or more computer apparatuses as needed. As an example, this embodiment employs the video transmission apparatus 101 having an omnidirectional camera with two fish-eye lenses 111.

The video reception apparatus 102 may be implemented as a dedicated apparatus such as a television receiver having a communication function, or as an apparatus that includes one or more computers as needed. The video reception apparatus 102 may also be implemented as a device such as a head-mounted display (HBD). This embodiment employs an example in which functions of the video reception apparatus 102 are realized by a computer and a video playing application program (hereinafter referred to as a video playing app) running in the computer.

In the video transmission apparatus 101 in FIG. 1, light captured by the fish-eye lenses 111 is converted by optical sensors 112 into electric signals. The electric signals are further digitized by an A/D converter 113 and processed into a video by an image signal processing circuit 114. The video transmission apparatus 101 in this embodiment includes two imaging systems, each having the combination of the fish-eye lens 111 and the optical sensor 112. In this embodiment, one of the two imaging systems images a spatial area at an angle of view of 180 degrees and the other imaging system images the adjacent spatial area at an angle of view of 180 degrees, thereby allowing acquisition of an omnidirectional 360-degree video. The A/D converter 113 is physically provided to each of the optical sensors 112, although only one A/D converter 113 is shown in FIG. 1 for simplicity of illustration.

The signals of the fish-eye images at an angle of view of 180 degrees acquired as above by the two respective imaging systems are sent to the image signal processing circuit 114. The image signal processing circuit 114 generates a 360-degree omnidirectional video from the 180-degree fish-eye images acquired by the two imaging systems, and converts the 360-degree video into videos in a form called equirectangular videos to be described below. A compression-encoding circuit 115 takes the 360-degree video data converted into the equirectangular form by the image signal processing circuit 114 and generates compressed MPEG-DASH-compliant video data. In this embodiment, the compressed video data generated by the compression-encoding circuit 115 is temporarily held in, e.g., a memory 119, and output from a communication circuit 116 to a network 103 in response to a transmission request from the video reception apparatus 102. Alternatively, the compressed video data generated by the compression-encoding circuit 115 may be accumulated in a location such as the web server 104 and then distributed from the web server 104 in response to a request from an entity such as the video reception apparatus 102.

A ROM 118 is read-only memory that stores programs and parameters requiring no modifications. The memory 119 is RAM (Random Access Memory) that temporarily stores programs and data provided by entities such as external apparatuses. A CPU 117, which is a central processing unit controlling the entire video transmission apparatus 101, executes a program related to this embodiment that may be read from the ROM 118 and loaded into the memory 119. The CPU 117 also performs the process of generating metadata about video data by executing the program. In this embodiment, the metadata includes transmission URLs and direction data about videos to be transmitted, as will be described in detail below. Although not shown, for purposes such as recording the video data, the video transmission apparatus 101 may include a storage medium such as removable semiconductor memory, and a read/write device for the storage medium.

The video reception apparatus 102 includes an apparatus such as a computer and has components such as a CPU 121, a communication I/F unit 122, a ROM 123, a RAM 124, an operation unit 125, a display unit 126, and a mass storage unit 127.

The communication I/F unit 122 can communicate with entities such as the web server 104 and the video transmission apparatus 101 over the network 103. In this embodiment, the communication unit 122 receives the above-mentioned metadata, transmits a distribution request to distribute compressed video data for video streaming, and receives the compressed video data distributed in response to the distribution request.

The ROM 123 stores various programs and parameters, and the RAM 124 temporarily stores programs and data. The mass storage unit 127, which may be a hard disk drive or a solid state drive, can store the compressed video data and the video playing app received by the communication I/F unit 122. The CPU 121 executes the video playing app read from the mass storage unit 127 and loaded into the RAM 124. In this embodiment, the CPU 121 executes the video playing app and controls components to acquire MPEG-DASH-compliant video data based on a transmission URL (to be described below) included in the metadata obtained in advance. Once acquiring the compressed video data, the CPU 121 decodes and decompresses the compressed video data and sends the data to the display unit 126. The display unit 126, which includes a display device such as a liquid crystal display, displays a video based on the video data decoded and decompressed by the CPU 121. The operation unit 125, which includes devices such as a mouse, keyboard, and touch panel used by a user for inputting instructions, outputs the user's instruction inputs to the CPU 121. If the video reception apparatus 102 is an HMD, the video reception apparatus 102 also includes a sensor capable of detecting changes in posture.

### Overview of Equirectangular Projection

This embodiment describes the example of converting a 360-degree video into equirectangular videos in the image signal processing circuit 114 of the video transmission apparatus 101. The reason for converting the 360-degree video into the equirectangular videos is that generating general rectangular videos facilitates video compression and display. The image signal processing circuit 114 may also perform a conversion process based on cubic projection as described in a second embodiment below, or even other conversion processes such as the one described in a third embodiment below. Although this embodiment illustrates the omnidirectional camera with the two fish-eye lenses 111, the camera may be an omnidirectional camera with many general lenses, or may be a 180-degree camera with only one fish-eye lens 111 that captures an angle of view of 180 degrees. If a 180-degree camera is used, a video obtained with the lens directed toward, e.g., the sky (upward) simply lacks the area of the downward angle of view of 180 degrees.

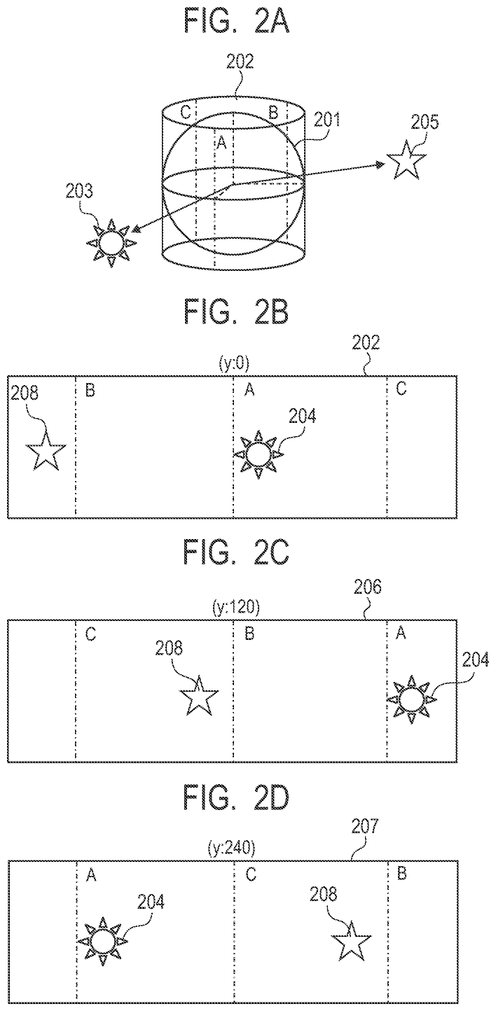

In order to make the following description dearer, the conversion of the 360-degree video into the equirectangular videos will further be described with reference to FIGS. 2A to 2B.

In FIG. 2A, a spherical virtual video surface 201 represents a 360-degree video viewed from a 360-degree camera located at the core of the sphere. A cylinder 202 surrounding the video surface 201 represents the surface of an equirectangular video into which the spherical virtual video surface 201 is converted. Dashed and single-dotted lines A, B, and C on the cylinder 202 represent lines corresponding to meridians on the spherical surface. If the directions in the rotating coordinate system for the spherical video surface 201 are expressed as roll (r), pitch (p), and yaw (y) directions, the dashed and single-dotted line A is a line (y:0) corresponding to the meridian indicated by an angle of 0 degree in the yaw direction. Similarly, the dashed and single-dotted line B is a line (y:120) corresponding to the meridian indicated by an angle of 120 degrees in the yaw direction; the dashed and single-dotted line C is a line (y:240) corresponding to the meridian indicated by an angle of 240 degrees in the yaw direction.

FIG. 2B to FIG. 2D are diagrams illustrating examples in which the spherical virtual video surface 201 in FIG. 2A, which is a 360-degree video, is converted into equirectangular videos.

FIG. 2B illustrates an equirectangular video resulting from converting the video surface 201 in FIG. 2A and unfolding the cylinder 202. The cylinder 202 is unfolded with the center line positioned on the dashed and single-dotted line A (the line (y:0)) corresponding to the meridian at an angle of 0 degree in the yaw direction. When the equirectangular video shown in FIG. 2B is displayed on the video reception apparatus 102, the video can be displayed as a horizontal 360-degree omnidirectional video by, e.g., connecting the laterally opposite ends of the video.

FIG. 2C illustrates an equirectangular video resulting from unfolding the cylinder 202 with the center positioned on the dashed and single-dotted line B (the line (y:120)) corresponding to the meridian at an angle of 120 degrees in the yaw direction. Similarly, FIG. 2D illustrates an equirectangular video resulting from unfolding the cylinder 202 with the center positioned on the dashed and single-dotted line C (the line (y:240)) corresponding to the meridian at an angle of 240 degrees in the yaw direction. As with the video in FIG. 2B, when the equirectangular videos shown in FIGS. 2C and 2D are displayed on the video reception apparatus 102, the videos can be displayed as horizontal 360-degree omnidirectional videos by, e.g., connecting the laterally opposite ends of the videos.

The cylinders 202, 206, and 207 are all views resulting from converting the virtual video surface 201 into an equirectangular video, but are different in that the center lines in the rectangles of the converted equirectangular videos are the dashed and single-dotted lines A, B, and C, respectively. In other words, they are different in where the center of extraction is set in the conversion into the equirectangular videos.

As apparent front FIGS. 2A to 2D, the area corresponding to the zenith of the sphere is expanded into the top circle of each of the cylinders 202, 206, and 207. Accordingly, the equirectangular-converted video is expanded and distorted to greater degrees at locations farther from the equator of the sphere and closer to the poles. A sum-shaped object 203 and a star-shaped object 205 in FIG. 2A represent exemplary objects shot by the 360-degree camera placed at the core of the sphere. The objects 203 and 205 shown in FIG. 2A are projected as respective objects 204 and 208 on the equirectangular-converted cylinders 202, 206, and 207 in FIGS. 2B to 2D.

### Generating and Transmitting MPEG-DASH-Compliant Video Data and Metadata

The flow of compression-encoding and transmitting the equirectangular-converted videos will now be described for an exemplary case of MPEG-DASH.

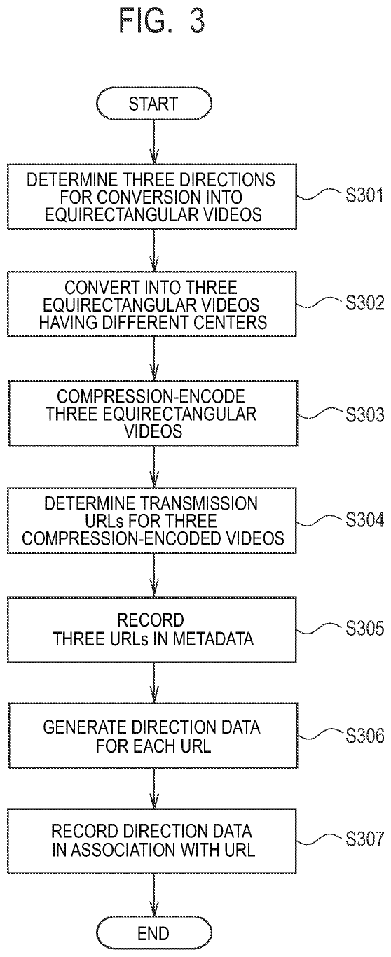

FIG. 3 is a flowchart illustrating the flow of a control process for compression-encoding and transmitting the equirectangular-converted videos by the video transmission apparatus 101 in this embodiment. In the following description, the steps S301 to S307 of the flowchart in FIG. 3 will simply be denoted as S301 to S307, respectively. The process of the flowchart in FIG. 3 may be performed in a software configuration or a hardware configuration, or in a software configuration in part and in a hardware configuration for the rest of the process. If the process is performed in a software configuration, the process is performed by the CPU 117 controlling other components by executing a program related to this embodiment stored in, e.g., the ROM 118. The program related to this embodiment may be stored in the ROM 118 in advance, or may be read from a medium such as removable semiconductor memory or downloaded over a network such as the Internet. The process of the flowchart in FIG. 3 is performed each time a 360-degree video is acquired.

First, at S301, the CPU 117 determines multiple center directions to be used in converting the above-described 360-degree video into equirectangular videos. In this embodiment, the CPU 117 determines three center directions corresponding to the three respective lines (y:0), (y:120), and (y:240) indicated by the angles of meridians in the yaw direction as described for FIGS. 2A to 2D above. Although this embodiment employs the three center directions, this is exemplary and the number of center directions are not limited to three. For example, two center directions rotated 180 degrees from each other may be employed, such as the directions of the line (y:0) corresponding to the meridian at an angle of 0 degree and the line (y:180) corresponding to the meridian at an angle of 180 degrees. Assuming that the direction of the line (y:0) corresponding to the meridian at an angle of 0 degree is the front, the direction of the line (y:180) corresponding to the meridian at an angle of 180 degrees is the back. The center directions may also not be based on the yaw direction but may be based on the pitch direction corresponding to the latitudinal direction.

At S302, the CPU 117 controls the image signal processing circuit 114 to generate, from the 360-degree video imaged and acquired as described above, three equirectangular videos corresponding to the three respective center directions determined at S301. That is, the image signal processing circuit 114 here performs equirectangular conversion to generate, from the single 360-degree video, three equirectangular videos with different center directions as shown in FIGS. 2B to 2D.

At S303, the CPU 117 controls the compression-encoding circuit 115 to compression-encode the three equirectangular videos generated at S302. The compression-encoding circuit 115 consequently generates three pieces of compressed video data corresponding to the three respective equirectangular videos. In response to a request from the video reception apparatus 102, these three pieces of compressed video data may be copied to an internal location from which the video data can be transmitted to the video reception apparatus 102, or may be copied to an internal location from which the video data can be transmitted to the video reception apparatus 102 after accumulated in an external location. Specifically, the video data is stored in a location such as the memory 119 or the web server 104.

At S304, the CPU 117 performs an address generation process for generating URLs that are address information indicating the locations of the three pieces of compressed video data. That is, in the address generation process, the CPU 117 generates transmission URLs to be used by the video reception apparatus 102 for requesting video data distribution. At S305, the CPU 117 records, in MPEG-DASH metadata, the transmission URLs corresponding to the three respective pieces of video data. In this embodiment, the metadata is a manifest file or an MPD file in MPEG-DASH.

Further, at S306, the CPU 117 performs a direction information generation process for generating direction information (hereinafter referred to as direction data) indicating the center directions determined at S301. Since the three transmission URLs corresponding to the three pieces of compressed video data are generated in this embodiment, the CPU 117 generates, in this direction information generation process, three pieces of direction data corresponding to the three transmission URLs.

At S307, the CPU 117 records the pieces of direction data in the metadata in association with their corresponding transmission URLs. After S307, the process of the flowchart in FIG. 3 terminates. The metadata is then transmitted from the communication circuit 116 to the video reception apparatus 102 over the network 103. The video reception apparatus 102 can thus refer to a transmission URL and the direction data recorded in the received metadata to acquire compressed video data corresponding to a desired direction.

### Overview of Metadata

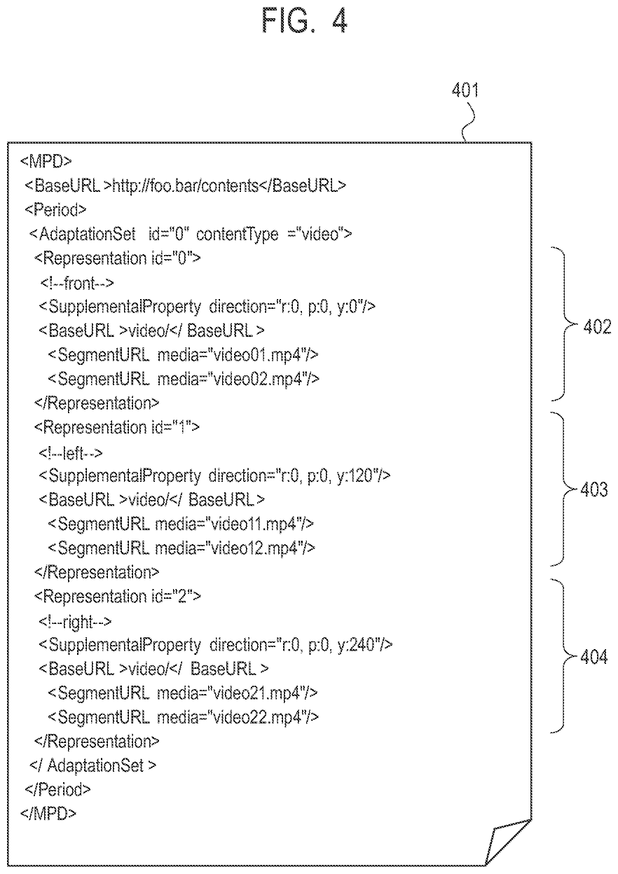

FIG. 4 is a diagram illustrating an example of the metadata (MPD) in an exemplary case of MPEG-DASH. Metadata may be called a manifest file in MPEG-DASH, so that FIG. 4 illustrates the metadata as a manifest file 401.

The manifest file 401 shown in FIG. 4 includes three representations 402, 403, and 404. Representations are units in MPEG-DASH that allow a video or audio to be switched according to the situation. In addition to a URL for acquiring a video, a first representation 402 includes the description [direction=“r:0, p:0, y:0”], which is the direction data generated at S306 described above. The direction data includes data indicating the roll (r), pitch (p), and yaw (y) directions in the rotating coordinate system. Similarly, a second representation 403 includes the direction data in which only the yaw (y) direction is set at 120 (y:120). This indicates that the video is rotated 120 degrees in the yaw direction (the horizontal direction) relative to the direction indicated by the representation 402. Similarly, a third representation 404 includes the direction data in which only the yaw (y) direction is set at 240 (y:240). This indicates that the video is rotated 240 degrees in the yaw direction relative to the direction indicated by the representation 402. Selecting any of the pieces of direction data in these representations 402 to 404 enables determining to request transmission of the video centered on the corresponding one of the lines (y:0) to (y:240) in FIGS. 2B to 2D described above.

For example, assume that the video with the center direction on the line (y:0) in FIG. 2B (r:0, p:0, y:0) is desired to be played on the display by the user of the video reception apparatus 102 having received the manifest file 401 in FIG. 4. The CPU 121 of the video reception apparatus 102 then acquires the compressed video data based on the transmission URL described in the representation 402 corresponding to the direction data [direction=“r:0, p:0, y:0”]. The video reception apparatus 102 can thus play on the display the front-side video (r:0, p:0, y:0) centered on the line (y:0) in FIG. 2B. If, for example, the video with the center direction on the line (y:120) in FIG. 2C is desired to be played on the display, the compressed video data is acquired from the transmission URL in the representation 403 corresponding to [direction=“r:0, p:0, y:120”]. The video reception apparatus 102 can thus play on the display the video centered on the line (y:120) in FIG. 2C.

If, for example, the back-side video opposite to the line (y:0) regarded as the front, i.e., the video with the center direction on the 180-degree meridian (y:180), is desired to be played on the display, the CPU 121 may obtain either one of the transmission URLs in the representations 403 and 404, This is because both the center lines (y:120) and (y:240) according to the representations 403 and 404 are displaced 60 degrees from the 180-degree meridian (y:180) and considered equivalent. As such, if the back-side video with the center direction on 180-degree meridian (y:180) is specified for playing on the display, the video reception apparatus 102 plays on the display the video acquired from a selected one of the transmission URLs in the representations 403 and 404.

If the video with the center direction on the line (y:0) in FIG. 2B is desired to be played on the display, the seam of the horizontal 360-degree omnidirectional video will be on the meridian displaced 180 degrees from the center line (y:0) (the position exactly opposite to the front). That is, the seam in this case is advantageously less noticeable to the user of the video reception apparatus 102 because it is at the user's back from the user's viewpoint. If the video with the center direction on the 180-degree line (y:180) is desired to be played on the display, the video centered on the line (y:120) or the line (y:240) is acquired. The seam of the horizontal 360-degree omnidirectional video in this case will be on a meridian displaced 60 degrees toward the 180-degree line (y:180) from the position exactly opposite to the 180-degree line. This seam may still not be highly noticeable to the user because of its distance from the center of the video.

The seam in displaying the horizontal (yaw-direction) 360-degree omnidirectional video has been described. It is to be noted that advantages in recording the direction data as described above are not limited to the advantages related to the processing of the seam.

### Example of Generating Pan-Direction Video

As described above, an equirectangular-converted video is distorted to greater degrees at locations farther from the equator of the sphere and closer to the poles. It may therefore not be preferable to acquire a video centered at the zenith (r:0, p:90, y:0) using, e.g., a video in which the line (y:0) is positioned at the front (r:0, p:0, y:0). If a video centered at the zenith (r:0, p:90, y:0) is generated in advance, it is desirable to use this video to play a zenith-side video on the display.

In this embodiment, therefore, as in the yaw-direction case described above, multiple pieces of video data with respect to the pan-direction (the latitudinal direction on the sphere) are generated and the above-described metadata generation process is performed. This enables obtaining videos with a smaller degree of distortion on the zenith side as well.

### Example of Varying Video Compression Bitrate

As a further example in this embodiment, varying the video compression bitrate according to the distance from the center line will be described with reference to, again, FIGS. 2A to 2D described above.

As described above, the cylinder 202 shown in FIGS. 2A and 2B is the equirectangular video centered on the dashed and single dotted line A. Here, assume that a video is going to be played on the video reception apparatus 102, and the center direction desired for playing on the display is specified to be the dashed and single-dotted line A. Then, for example, the video part between the dashed and single-dotted lines B and C, i.e., the back-side video part relative to the front-side video part centered on the dashed and single-dotted line A is considered less important than the front-side video part. For example, on the cylinder 202 in FIG. 2B, the sun-shaped object 204 may be of higher importance while the star-shaped object 205 may be of lower importance. For video parts of lower importance, modification such as reducing the video compression bitrate may not significantly affect the visual recognizability.

In this embodiment, therefore, the CPU 117 of the video transmission apparatus 101 controls the compression-encoding circuit 115 to, e.g., set lower video compression bitrates at locations farther from the center line (A) in the yaw direction. In other words, the closer to the center line, the higher the video compression bitrate. Accordingly, the area containing the sun-shaped object 204 in FIG. 2B has a higher video compression bitrate, whereas the area containing the star-shaped object 208 has a lower video compression bitrate. Similarly, for the cylinder 206 in FIG. 2C, the video compression bitrate is set lower at locations farther from the center line (B). Accordingly, the area containing the sun-shaped object 204 has a lower video compression bitrate, whereas the area containing the star-shaped object 208 has a higher video compression bitrate.

As described above, if the video centered on the line (y:0) is to be played on the display, the video reception apparatus 102 acquires the video data based on the transmission URL described in the representation 402 in FIG. 4. If the video centered on the line (y:120) is to be played on the display, the video reception apparatus 102 acquires the video data based on the transmission URL described in the representation 403 in FIG. 4. Here, the control is performed to set higher video compression bitrates at locations closer to the center line, as described above. Consequently, in either case, the center part of the video has little degradation in image quality and the user can view the video with high visual recognizability. On the other hand, the control is performed to set lower video compression bitrates at locations farther from the center line, so that the total transmission bitrate in acquiring the video data is kept low.

### Description Examples Not Based on Rotating Coordinate System

The above description employs the example in which the direction data is information in the rotating coordinate system, for example (r:0, p:0, y:0). This information in the rotating coordinate system can be readily converted into information in, e.g., a normalized rectangular coordinate system. That is, the direction data in the rotating coordinate system (r:0, p:0, y:0) may also be described as direction data in a rectangular coordinate system, such as (x, y, z)=(0, 0, 0).

Alternatively, the direction data may be described as direction data in terms of the angle relative to the direction in the first representation 402 in FIG. 4 or some other predetermined direction, For example, for a video centered at (r:0, p:0, y:0), the back direction may be described as (yaw+180) instead of (r:0, p:0, y:180). Which description format is used as the direction data can be appropriately set for the system to which this embodiment is applied.

As has been described, in the first embodiment, metadata is used to specify the locations of videos (transmission URLs). The metadata describes multiple videos corresponding to different directions generated from a wide-field video such as an omnidirectional video, and also describes pieces of direction data in association with their corresponding videos. The video reception apparatus 102 can thus refer to a transmission URL and the direction data described in the metadata to acquire an appropriate video, in the wide-field video such as an omnidirectional image, corresponding to the direction desired for playing on the display.

### Second Embodiment

The first embodiment has been described for the example of converting a 360-degree video into equirectangular videos. In a second embodiment below, an example of converting a 360-degree video into a cubic form will be described. The configurations of entities such as the video transmission apparatus 101 and the video reception apparatus 102 in the second embodiment are the same as in FIG. 1 and therefore will not be shown.

In the second embodiment, the image signal processing circuit 114 of the video transmission apparatus 101 converts the above-described 360-degree video into a cubic form and further unfolds the cube to generate an unfolded cubic video, as will be described below. From video data about the unfolded cubic video resulting from unfolding the cube by the image signal processing circuit 114, the compression-encoding circuit 115 generates MPEG-DASH-compliant compressed video data. The CPU 117 performs a metadata generation process for the unfolded cubic video. Details of direction data described in the metadata in the second embodiment will be described below. The video reception apparatus 102 in the second embodiment acquires the MPEG-DASH-compliant video data based on a transmission URL and the direction data included in the metadata and displays the video data on the display unit 126.

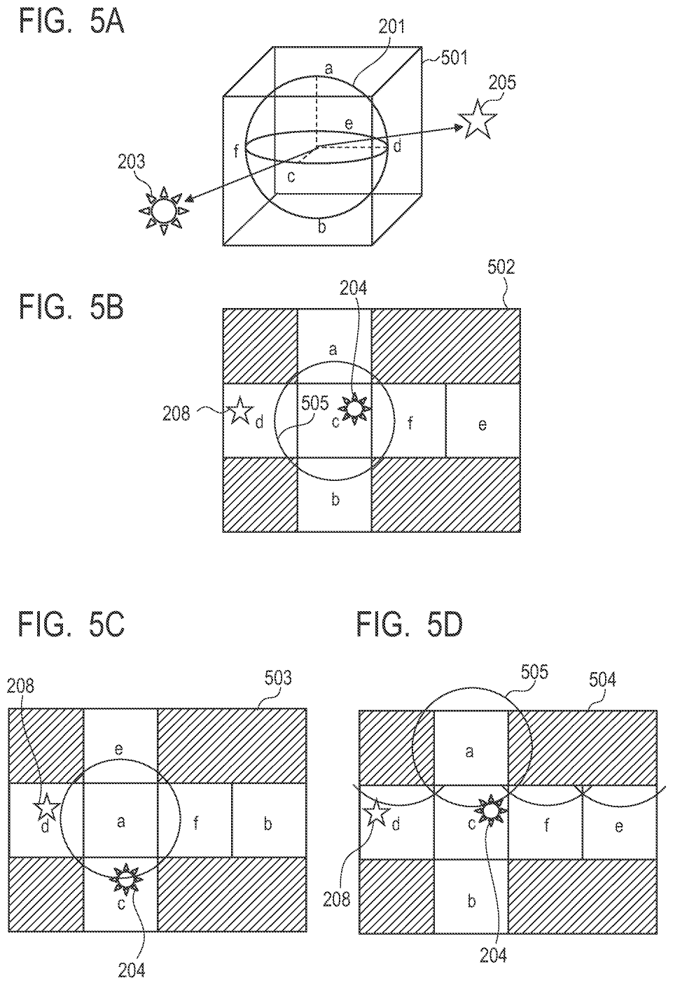

An example of converting a 360-degree video into a cubic form to generate an unfolded cubic video in the second embodiment will be described below with reference to FIGS. 5A to 5D and again the above-described flowchart in FIG. 3.

In FIG. 5A, as described above, the spherical virtual video surface 201 represents a 360-degree video viewed from a 360-degree camera located at the core of the sphere. The sun-shaped object 203 and the star-shaped object 205 are also as described above. In the second embodiment, the spherical virtual video surface 201 is projected onto a cube 501. FIG. 5B is a diagram illustrating a cubic projected video 502 unfolded with its center being the face c of the cube 501 in FIG. 5A. The objects 204 and 208 in FIG. 5B represent the objects 203 and 205 in FIG. 5A projected on the cubic projected video 502. Although the cubic projected video 502 is unfolded with its center being the face c in this example, the video may be unfolded in different manners. For example, the video may be unfolded into a rectangle of ¾ the width and ⅔ the height such that the face b is located on the left of the face a with the face c in between and the face e is located on the immediately right of the face a.

FIG. 5C illustrates a cubic projected video 503 unfolded with its center being the face a of the cube 501 in FIG. 5A. In other words, whereas the cubic projected video 502 in FIG. 5B is centered about the sun-shaped object 204 located at a lower position, the cubic projected video 503 in FIG. 5C is centered about the top face a of the cube. In the second embodiment, video data about the cubic projected videos 502 and 503 in FIGS. 5B and 5C is compression-encoded as described above. The manner of unfolding the cube 501 is not limited to the above examples.

Here, assume that the cubic projected video 502 in FIG. 5B is assigned varying image characteristics such that the face c in the center area has higher image quality and the other faces (a, b, d, e, and f) in the surrounding areas have a reduced amount of code (lower image quality). For the example of FIG. 5B, the CPU 117 of the video transmission apparatus 101 controls the compression-encoding circuit 115 so that the area inside a circle 505 illustrated in the cubic projected video 502 has higher image quality. Similar control is performed for the cubic projected video 503 in FIG. 5C. In this manner, if the focus of interest is the sun-shaped object 204, the compression-encoded video data about the cubic projected video 502 in FIG. 5B may be played on the video reception apparatus 102 to display the object 204 of higher image quality. If the focus of interest is the face a, the compression-encoded video data about the cubic projected video 503 in FIG. 5C may be played on the video reception apparatus 102 to display the video in which the face a has higher image quality.

A cubic projected video 504 in FIG. 5D has the same face arrangement as the cubic projected video 502 in FIG. 5B. The example in FIG. 5D only differs from FIG. 5B in the position of the circle 505 indicating the higher image quality area and can be processed in a similar manner. For the cubic projected video 504 in FIG. 5D, the higher image quality area indicated by the circle 505 includes the face a and part of the face c, as well as part of the faces d, f, and e, which are adjacent to the face a when folded into the cube.

No video is contained in the diagonally shaded areas in the cubic projected videos 502 to 504 shown. The amount of code in these areas can be significantly reduced by regarding these areas as, e.g., skipped macroblocks not to be encoded. The second embodiment thus enables transmitting a video with a specific face of higher image quality to the video reception apparatus 102 while reducing the total data traffic in the network 103.

The flow of compression-encoding and transmitting the converted cubic projected videos in the second embodiment is generally the same as in the above-described flowchart in FIG. 3. In the second embodiment, however, the 360-degree video is converted into cubic projected videos, and the metadata records transmission URLs that each associate a cubic projected video and a specific face positioned at the center or assigned a characteristic such as higher image quality.

In the second embodiment, at S301 in FIG. 3, the CPU 117 of the video transmission apparatus 101 determines multiple specific faces to be positioned at the center or assigned a characteristic such as higher image quality in unfolded cubic projected videos to be obtained from the 360-degree video. The multiple specific faces determined here may be, e.g., the face c in FIG. 5B, the face a in FIG. 5C, and the face a in FIG. 5D, as described above.

At S302, the CPU 117 controls the image signal processing circuit 114 to generate, from the above-described 360-degree video, cubic projected videos centered on the faces determined as the center faces at S301.

Further, at S303, the CPU 117 controls the compression-encoding circuit 115 to compression-encodes the video data about each cubic projected video generated at S302. The compression-encoding circuit 115 consequently generates compressed video data corresponding to each cubic projected video. As described above, the compression-encoding here includes performing the process of increasing the image quality of the faces determined to have higher image quality at S301 (the faces corresponding to the circle 505). In response to a request from the video reception apparatus 102, the compressed video data about each cubic projected video may be copied to an internal location from which the video data can be transmitted to the video reception apparatus 102, or may be copied to an internal location from which the video data can be transmitted to the video reception apparatus 102 after accumulated in an external location.

At S304, the CPU 117 determines transmission URLs that are address information indicating the locations of the respective pieces of compressed video data. Further, at S305, the CPU 117 records, in the metadata, the transmission URLs corresponding to the respective pieces of compressed video data.

Further, at S306, the CPU 117 generates direction data indicating each specific face determined to be the center or to have higher image quality at S301. That is, the direction data in the second embodiment is, e.g., data indicating the specific face positioned at the center or assigned higher image quality, among the faces of the cube onto which the 360-degree video on the video surface 201 in FIG. 5A is projected. At S307, the CPU 117 records the pieces of direction data in the metadata in association with their corresponding transmission URLs.

The metadata is transmitted from the communication circuit 116 to the video reception apparatus 102 over the network 103 in the second embodiment as well. The video reception apparatus 102 in the second embodiment can thus refer to a transmission URL and the direction data recorded in the received metadata to acquire compressed video data corresponding to a desired direction.

### Overview of Metadata in Second Embodiment

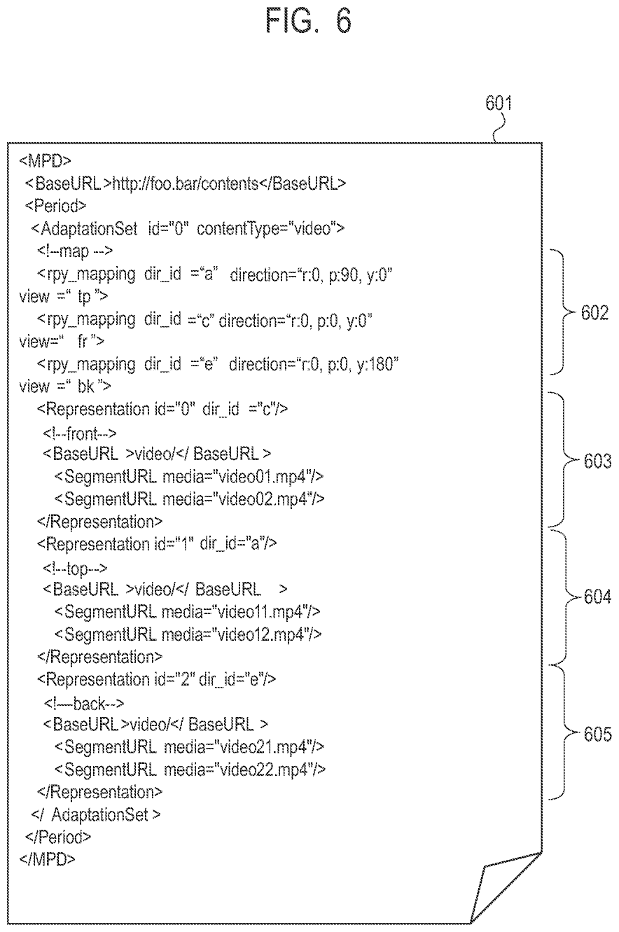

FIG. 6 is a diagram illustrating an example of the metadata in an exemplary case of MPEG-DASH in the second embodiment. As in FIG. 4 described above, FIG. 6 illustrates the MPEG-DASH-based metadata as a manifest file 601.

As described in the first embodiment, the manifest file 601 in FIG. 6 includes three representations 603, 604, and 605. Unlike the first embodiment, the second embodiment separately predefines the direction data generated at S306 in FIG. 3, such as [direction=“r:0, p:0, y:0”]. This will herein be referred to as a map 602. It is to be understood that the direction data may also be described according to the example in the first embodiment without using such a map. The map 602 further includes descriptions such as [view=“tp”], which describes, as a symbol, that [direction=“r:0, p:90, y:0”] indicates the vertically upward direction. Predefining directions as symbols, e.g., [view=“fr”] meaning the front and [view=“bk”] meaning the back, allows the directions to be more simply indicated.

A first representation 603 in FIG. 6 includes a URL for acquiring a video, as well as the description [dir_id=“c”], which indicates referring to [rpy_mapping dir_id=“c”] in the map 602. In this manner, simplified description of the representations and flexible description of the direction data can be realized. Although not described in detail, this also applies to the representations 604 and 605. The description of the direction data as in FIG. 6 can be adopted irrespective of the projection scheme.

As has been described, the video transmission apparatus 101 in the second embodiment converts a 360-degree video into cubic projected videos and describes, in metadata, direction data indicating specific projected faces. Thus, also in the second embodiment, the video reception apparatus 102 can acquire, based on the metadata, an appropriate video corresponding to the direction desired for playing on the display.

### Third Embodiment

The above example of convening the 360-degree video into the equirectangular videos described with reference to FIGS. 2A to 2D in the first embodiment is also applicable to the case of generating videos along partial circumferences using part of the cylinder 202. A third embodiment describes an application in which partial-circumference videos are generated using part of the cylinder 202.

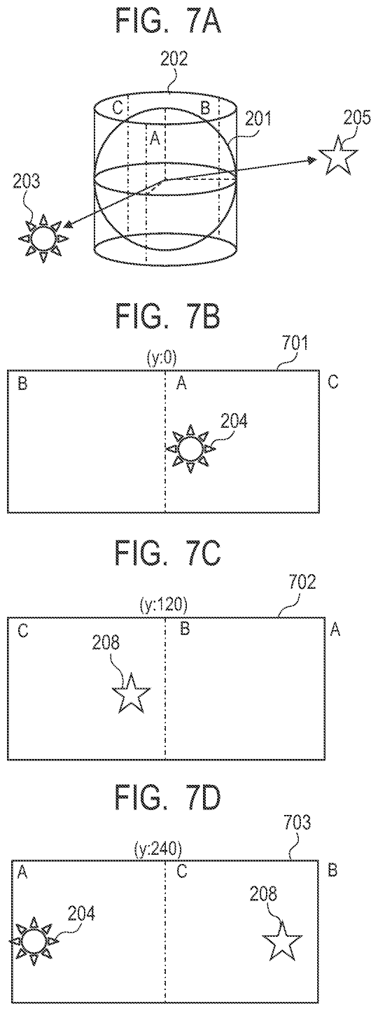

With reference to FIGS. 7A to 7D, the third embodiment describes an example in which 240-degree videos are generated as partial-circumference videos corresponding to part of the cylinder 202.

As in FIG. 2A described above, the spherical virtual video surface 201 in FIG. 7A represents a video viewed from a 360-degree camera located at the core of the sphere. The cylinder 202 represents a video into which the video surface 201 is converted with equirectangular projection. As described above, the dashed and single-dotted lines A, B, and C on the cylinder 202 are lines corresponding to meridians on the spherical surface.

FIG. 7B illustrates a partial cylindrical video 701 resulting from converting the video surface 201 in FIG. 7A with equirectangular projection and extracting an area extending over 240 degrees from the cylinder 202 with the center line positioned on the dashed and single-dotted line A (line (y:0)). Similarly, FIGS. 7C and 7D illustrate partial cylindrical videos 702 and 703 resulting from extracting areas extending over 240 degrees from the cylinder 202 with the center line positioned on the dashed and single-dotted lines B (line (y:120)) and C (line (y:240)), respectively.

As shown in FIGS. 7B to 7D, the areas extending over 240 degrees with different center lines are extracted. Accordingly, for example, the partial cylindrical videos 702 and 703 include video parts not included in the partial cylindrical video 701. Similarly, the partial cylindrical videos 701 and 703 include video parts not included in the partial cylindrical video 702, and the partial cylindrical videos 701 and 702 include video parts not included in the partial cylindrical video 703. If, for example, the sun-shaped object 203 in the partial cylindrical video 701 is viewed on the video reception apparatus 102, the corresponding projected object 204 can be seen while the projected object 208 of the star-shaped object 205 cannot be seen. However, if the video reception apparatus 102 is an HMD for example, the wearer of the HMD viewing a certain direction does not require the video part in the opposite direction, so that the lack of certain video parts may not cause significant trouble. As such, as illustrated by the manifest file 401 in FIG. 4 described above, the direction data may be used to obtain an appropriate representation in the third embodiment as well.

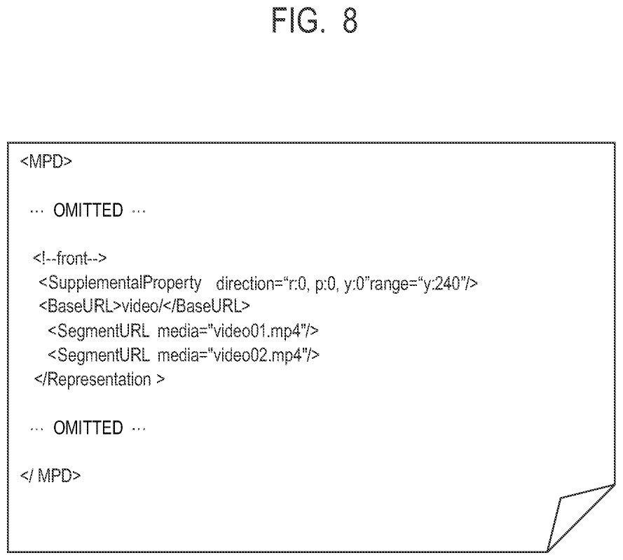

FIG. 8 illustrates exemplary descriptions in a manifest file that is exemplary metadata in the third embodiment. Although the above-described manifest file 401 may also be applied to the third embodiment, the manifest file in FIG. 8 further includes the description [range=“y:240”]. In this manner, the video reception apparatus 102 referring to the manifest file in FIG. 8 can know that this representation holds a video extending over 240 degrees in the yaw direction. It is to be understood that other directions such as the roll and pitch directions may be used in combination with the yaw direction in the third embodiment as well.

As has been described, in the third embodiment, partial-circumference video data corresponding to part of the cylinder 202 is transmitted. This enables further reduction in transmission bitrate. As in the first embodiment, the video compression bitrate may be set higher in the center area around the center line and lower in the surrounding areas in the third embodiment as well.

### Fourth Embodiment

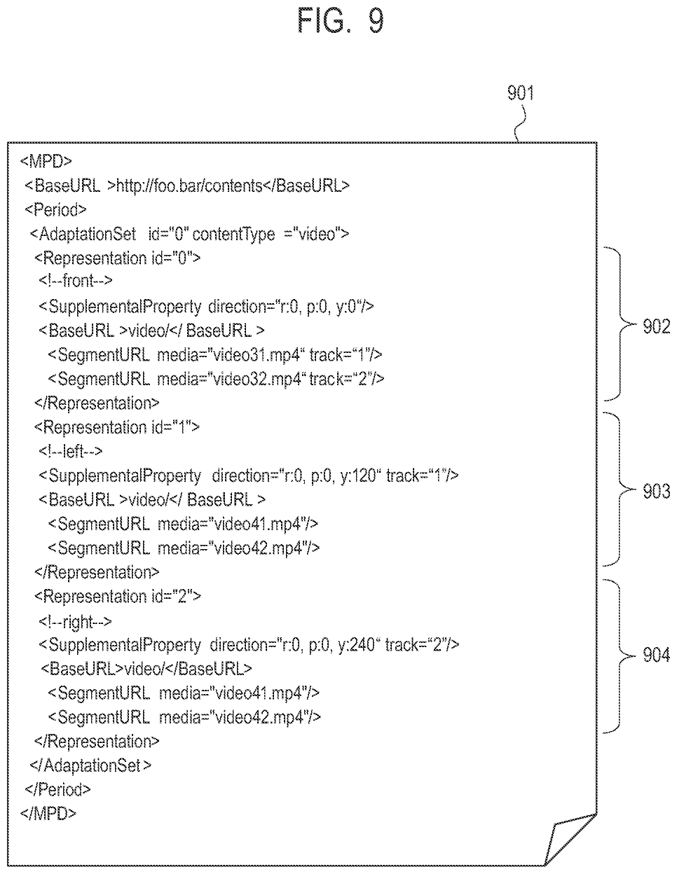

The above first to third embodiments have been described for the examples regarding MPEG-DASH and manifest files. In a fourth embodiment, another exemplary manifest file will be described. FIG. 9 is a diagram illustrating a further example of the manifest file described with reference to FIG. 4.

A manifest file 901 shown in FIG. 9 has a structure seemingly similar to the manifest file 401 described for FIG. 4, In the manifest file 901 in FIG. 9, however, a first representation 902 has [track=“1”] and [track=“2”] added to SegmentURLs. These descriptions indicate referring to the specified tracks in video31.mp4 and video32.mp4, respectively. That is, the representation 902 specifying [direction=“r:0, p:0, y:0”] is intended for acquiring the specific tracks in the media files specified by the SegmentURLs.

Tracks will be briefly described. As the file extension implies, the media files in this example are media data in a file format based on ISOBMFF (ISO/IEC 14496-12). Such files have a mechanism for storing multiple media items called tracks. The representation 902 is written so that media content corresponding to the relevant direction is acquired using media items (media data) stored in the specified tracks in the specified files. The two consecutive media files specify the different tracks because these media files are supposed to be independent from each other but to include tracks storing media items corresponding to the same direction.

In representations 903 and 904, a direction description such as [direction=“r:0, p:0, y:120”] is followed by a description such as [track=“1”] or [track=“2”]. The media files specified in the representations 903 and 904 are identical. That is, the representations 903 and 904 refer to the same media flies. In each of the representations 903 and 904, a single track is specified for both the consecutive media files; for example, in the representation 903, the track [track=“1”] is applied to both the consecutive media tiles. In this manner, according to the third embodiment, different directions can be described based on the same media files.

### Other Embodiments

While the above description has taken MPEG-DASH as an example, embodiments are applicable not only to MPEG-DASH-based systems but to systems that transmit and receive videos using a combination of a metadata file and media files. For example, what is commonly called HTTP Live Streaming adopts a format called m3u for the manifest file. This format allows recording the locations from where media data is to be acquired. The direction data, e.g., [direction=“r:0, p:0, y:120”], can be added as additional information to this format to realize what has been described above.

The present invention may include aspects such as a system, an apparatus, a method, a program, and a recording medium (storage medium), for example. Specifically, the present invention may be applied to a system that include multiple devices (for example, a host computer, an interface device, an imaging apparatus, and a web application) or to an apparatus implemented as a single device. The system may be a cloud system that includes a group of distributed virtual computers.

The present invention may be realized in a manner that a program for implementing one or more functions of the above-described embodiments is supplied to a system or an apparatus via a network or a storage medium, and one or more processors of a computer in the system or apparatus read and execute the program. The present invention may also be realized by a circuit (for example, an ASIC) for implementing the one or more functions.

Any of the above-described embodiments is only an exemplary implementation of the present invention, and the technical scope of the present invention should not be construed as being limited by these embodiments. The present invention may therefore be implemented in various forms without departing from its technical principles or essential features.

According to the present invention, a reception apparatus can appropriately know the direction of a video.

The present invention is not limited to the above embodiments and allows various modifications and variations without departing from the spirit and scope of the present invention, The following claims are thus appended in order to publicize the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information processing apparatus comprising:
a direction information generation unit that generates, for two or more second videos corresponding to two or more different directions generated from a first video, direction information indicating the two or more directions;
an address generation unit that generates address information to be used by a reception apparatus for acquiring any of the second videos; and
a metadata generation unit that generates metadata in which the two or more second videos are associated with the address information and the direction information.

2. The information processing apparatus according to claim 1, further comprising a transmission unit that transmits the metadata to the reception apparatus.

3. The information processing apparatus according to claim 1, further comprising a video generation unit that generates the two or more second videos corresponding to the two or more different directions from the first video.

4. The information processing apparatus according to claim 3, wherein the video generation unit generates the two or more second videos having different image characteristics from the first video.

5. The information processing apparatus according to claim 3, wherein the video generation unit generates the two or more second videos having different center positions from the first video.

6. The information processing apparatus according to claim 4, wherein the video generation unit performs direction-dependent predetermined processing on the two or more second videos.

7. The information processing apparatus according to claim 6, wherein the video generation unit performs the predetermined processing in which a video compression bitrate is changed according to the directions.

8. The information processing apparatus according to claim 6, wherein the video generation unit performs the predetermined processing in which image quality is changed according to the directions.

9. The information processing apparatus according to claim 8, wherein the video generation unit performs the predetermined processing so that a center video area and a surrounding video area are further different in image quality.

10. The information processing apparatus according to claim 3, wherein
the first video from which the two or more second videos are generated is a 360-degree omnidirectional video, and
the video generation unit generates, from the 360-degree omnidirectional video, two or more equirectangular videos as the two or more second videos.

11. The information processing apparatus according to claim 3, wherein
the first video from which the two or more second videos are generated is a 360-degree omnidirectional video, and
the video generation unit generates, from the 360-degree omnidirectional video, two or more cubic projected videos as the two or more second videos.

12. The information processing apparatus according to claim 1, wherein the direction information generation unit generates direction information indicating roll, pitch, and yaw directions in a rotating coordinate system.

13. The information processing apparatus according to claim 1, wherein the direction information generation unit uses, as the direction information, a symbol representing a predetermined direction.

14. The information processing apparatus according to claim 1, wherein the address information comprises a URL, or a combination of a URL and information that specifies part of a media file specified by the URL.

15. A system comprising:
a transmission apparatus comprising the information processing apparatus according to claim 1; and
a reception apparatus that acquires any of the second videos based on the address information and the direction information in the metadata generated by the information processing apparatus.

16. A method for processing information performed by an information processing apparatus, comprising:
generating, for two or more second videos corresponding to two or more different directions generated from a first video, direction information indicating the two or more directions;
generating address information to be used by a reception apparatus for acquiring any of the second videos; and
generating metadata in which the two or more second videos are associated with the address information and the direction information.

17. A non-transitory computer-readable storage medium having stored thereon a program for causing a computer to function as units of an information processing apparatus comprising:
a direction information generation unit that generates, for two or more second videos corresponding to two or more different directions generated from a first video, direction information indicating the two or more directions;
an address generation unit that generates address information to be used by a reception apparatus for acquiring any of the second videos; and
a metadata generation unit that generates metadata in which the two or more second videos are associated with the address information and the direction information.
